(19) United States
(12) Patent Application Publication
(10) Pub. No.: US 2010/0230456 A1
(43) Pub. Date: Sep. 16, 2010

(54) HOLDING DEVICE

(75) Inventor: Kurt BEYER, Wiesbaden (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/721,344

(22) Filed: Mar. 10, 2010

(30) Foreign Application Priority Data
Mar. 11, 2009 (DE) 102009012737.2

(51) Int. Cl. B60R 11/00

(52) U.S. Cl. 224/539

(57) ABSTRACT

A holding device is provided for holding articles within an interior space of a motor vehicle, that includes, but is not limited to a container box with a closable lid element. The container box can be fastened in a rail system arranged in a center console of the motor vehicle. This makes possible to make available a holding device for the holding of articles within an interior space of a motor vehicle, which makes possible safe holding of articles of consumption, more preferably of larger articles of consumption, and in addition can be comfortably reached by all vehicle occupants of the motor vehicle.

### CROSS-REFERENCE TO RELATED APPLICATION

This application claims priority to German Patent Application No. 102009012737.2, filed Mar. 11, 2009, which is incorporated herein by reference in its entirety.

### TECHNICAL FIELD

The invention relates to a holding device for holding articles within an interior space of a motor vehicle, for example in order to store or safely place these articles of consumption.

### BACKGROUND

Articles of consumption, more preferably articles of consumption which are no longer needed and constitute waste, are usually placed loosely on the co-driver's seat, on one of the back seats or in the foot well of a motor vehicle, as a result of which the interior space of the motor vehicle can easily appear untidy. In the front region of the motor vehicle below the sound system a small compartment is usually provided in which waste such as cigarette butts or small slips of paper can be placed, but this compartment is far too small for placing a plurality or larger articles in it at the same time and vehicle occupants in the back region of the vehicle can also reach this compartment only with difficulty. In addition, there is the risk that the articles loosely placed in the vehicle can topple over while driving, slide off the seats and as a result can get under the seats when they can no longer be reached more especially by the driver. More preferably when driving through curves or during braking operations the loosely placed articles can slide to and fro in the vehicle.

If the driver should look for one of these articles while driving, for example in the region of the co-driver's seat, the risk of an accident increases as well. It is therefore at least one object of the invention to make available a holding device for holding articles within an interior space of a motor vehicle which makes possible safe holding of articles of consumption, more preferably of larger articles of consumption and in addition is comfortably reachable for all vehicle occupants of the motor vehicle. In addition, other objects, desirable features, and characteristics will become apparent from the subsequent summary and detailed description, and the appended claims, taken in conjunction with the accompanying drawings and this background.

### SUMMARY

The holding device for holding articles within an interior space of a motor vehicle according to an embodiment of the invention comprises a container box with a closable lid element, wherein the container box can be fastened in a rail system arranged in a center console of a motor vehicle.

The holding device comprises a container box in which articles of consumption, more preferably articles of consumption with larger dimensions, can be safely placed in the interior space of a motor vehicle. Here, the container box can preferably serve as waste container. Through the lid element the container box can be securely closed, which is advantageous more preferably when the container box serves as waste container. By placing the container box in the center console of the motor vehicle it is easily reachable by the driver, the co-driver as well as the occupants on the rear seat bench of the vehicle. The center console of the motor vehicle comprises a rail system which is preferentially constructed of two rails which run parallel to each other and which extend from the instrument panel to behind the front seats in the region of the rear seat benches of the vehicle. The container box can be preferentially fastened in the rail system between the two back rests of the driver's seat and the co-driver's seat, so that all occupants can easily reach the container box without the container box restricting or obstructing the vehicle occupants on the rear seat benches in the space available to them. Furthermore it is possible with the help of the holding device according to the invention in a simple manner to safely stow articles of consumption while driving, so that the articles cannot topple over or slide to and fro in the vehicle, so that the vehicle interior is also protected.

In order to be able to fasten the container box in the rail system the container box according to an advantageous embodiment of the invention comprises pin-shaped fastening elements. These pin-shaped fastening elements can be hooked into the rails of the rail system, wherein the container box by means of the pin-shaped fastening elements is preferentially positioned in a fixed position of the rail system, so that the container box cannot slide to and fro in the rail system even during more severe braking operations or when driving through curves. To achieve safe fastening, preferentially two fastening elements each are provided on the lateral surface of the container box which point in the direction of the driver's seat, and two fastening elements each on the lateral surface of the container box which point in the direction of the co-driver's seat.

According to a preferred embodiment of the invention, two fastening elements located opposite each other are coupled together by means of a spring mechanism. By means of the spring mechanism the fastening elements can be easily moved within the container box for fastening and releasing the container box in the rail system. In that two fastening elements located opposite each other are coupled together by means of a spring mechanism, wherein the one fastening element points in the direction of the driver's seat and the other fastening element points in the direction of the co-driver's seat, these can be moved as a function of each other, which facilitates the movement sequence when inserting and releasing the fastening elements in the rail system.

For fastening and/or releasing the container box in the rail system a first actuation element can be provided on the container box according to a preferred embodiment of the invention. The actuation element is preferentially coupled with the pin-shaped fastening elements, so that the fastening elements can be moved by means of the actuation element. For example, the fastening elements can be moved in the direction of the container box through actuating the actuation element, so that the fastening elements are unhooked from the rails of the rail system and the container box can be released. The actuation element can for example be embodied as a pulling knob or a pushing knob, so that when exerting a force on the pulling knob or the pushing knob, the fastening elements are moved in the direction of the container box in order to be able to release the container box and as soon as the pulling knob or pushing knob is no longer actuated, the fastening elements are moved to the outside of the container box, so that the container box for example can be hooked into the rails again. The actuation element however can also be equipped with a mechanism other than a pulling or pushing knob.

For opening and closing the lid element of the container box the container box according to a further embodiment of the invention can comprise a second actuation element, which for example can likewise be embodied as pushing knob.

According to a further embodiment of the invention the lid element can be configured foldable, slidable or collapsible. The lid element can consist of a plurality of parts which can be moved separately from one another. Here, the lid element can be configured as a flap or as a roll-up shutter.

Within the container box a fastening element for fastening a removable holding element can preferentially be provided. The removable holding element can for example be a waste bag, which for example can be fastened within the container box by means of an elastic band or by means of a metal clip as fastening element.

According to a further preferred embodiment of the invention, the holding device can comprise a second container box. The second container box can likewise be fastened in the rail system of the center console. The second container box can for example serve for the storage of unused waste bags, in order to have these always at hand when the waste bag located in the first container box is to be replaced.

The invention furthermore relates to a center console of a motor vehicle which comprises a rail system, in which a holding device embodied and further developed as above can be arranged.

### BRIEF DESCRIPTION OF THE DRAWINGS

The present invention will hereinafter be described in conjunction with the following drawing figures, wherein like numerals denote like elements, and

FIG. 1 a schematic representation of an arrangement of a holding device according to an embodiment of the invention in a rail system;

FIG. 2 a schematic representation of a holding device according to and embodiment of the invention;

FIG. 3 a schematic representation of fastening elements according to an embodiment of the invention;

FIG. 4 a schematic representation of a holding device according to an embodiment of the invention according to a first possible use; and

FIG. 5 a schematic representation of a holding device according to an embodiment of the invention according to a second possible use.

### DETAILED DESCRIPTION

The following detailed description is merely exemplary in nature and is not intended to limit application and uses. Furthermore, there is no intention to be bound by any theory presented in the preceding background or summary or the following detailed description.

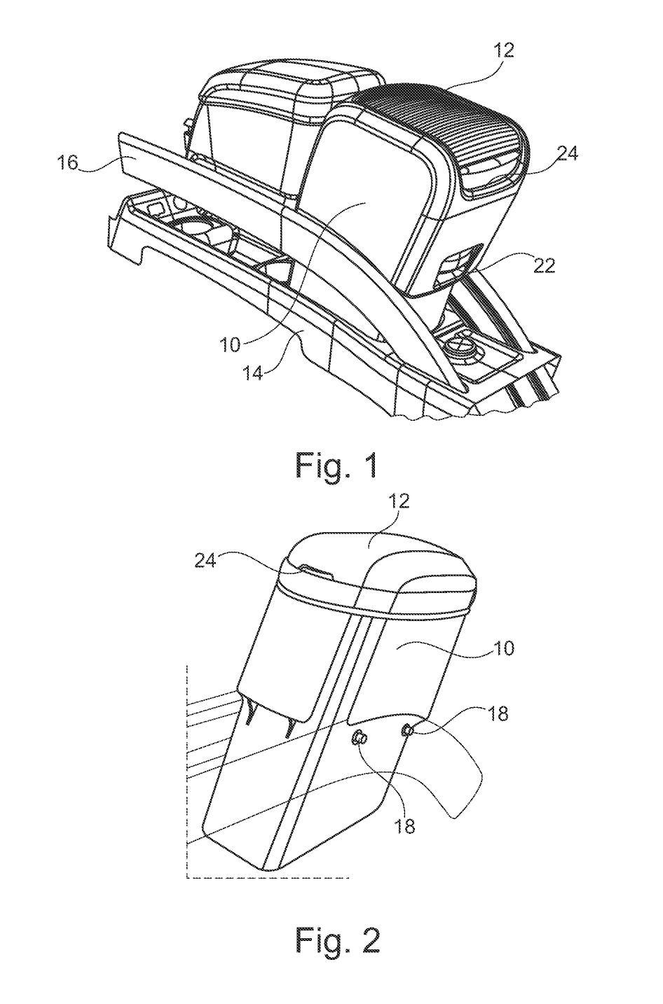

FIG. 1 shows a holding device according to an embodiment of the invention for holding articles within an interior space of a motor vehicle, which comprises a container box 10 with a closable lid element 12. The container box 10 can be fastened in a rail system 16 which is arranged in a center console 14 of a motor vehicle. The rail system 16 is preferentially constructed of two rails which run parallel to each other and extends from the instrument panel to behind the front seats in the region of the rear seat benches of the vehicle.

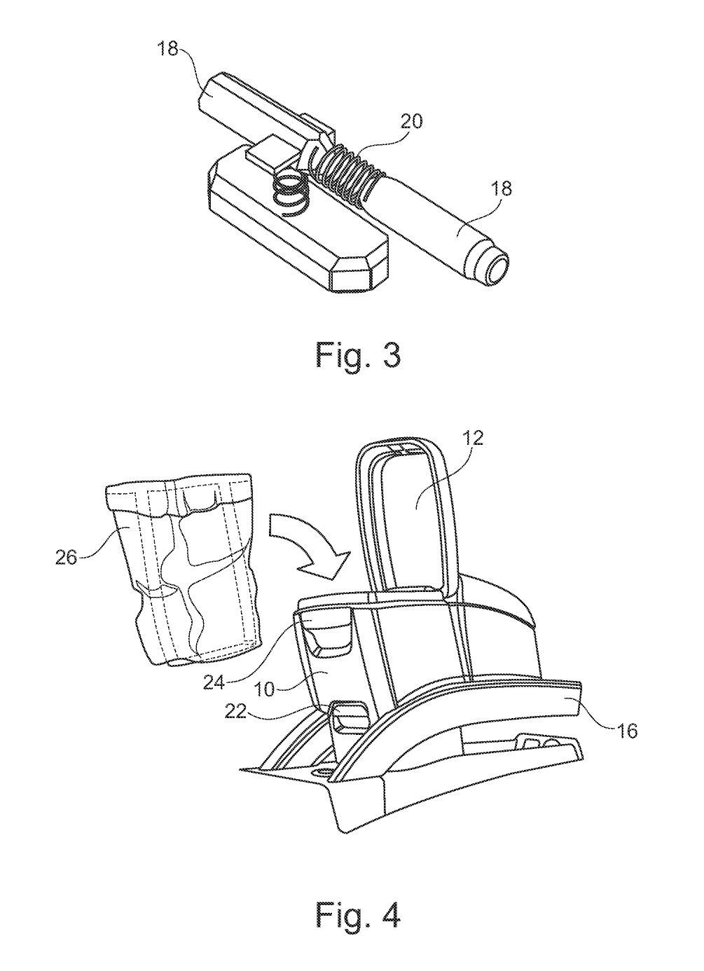

As shown in FIG. 2, the container box 10 can be fastened in the rail system 16 by means of pin-shaped fastening elements 18. These pin-shaped fastening elements 18, as they are also shown in FIG. 3, can be hooked into the rails of the rail system 16, wherein the container box 10 by means of the pin-shaped fastening elements 18 is preferentially positioned in a fixed position of the rail system 16, so that even during more severe braking operations or when driving through curves the container box 10 cannot slide to and fro in the rail system 16. In order to achieve safe fastening, two fastening elements 16 each are preferentially provided on the lateral surface of the container box 10, which point in the direction of the driver's seat, and two fastening elements 18 each are provided on the lateral surface of the container box 10, which point in the direction of the co-driver's seat. As is shown in FIG. 3, two opposing fastening elements 18 can be coupled to each other by means of a spring mechanism 20.

For fastening and/or releasing the container box 10 in the rail system 16 the container box 10 comprises a first actuation element 22. The actuation element 22 is preferentially coupled with the pin-shaped fastening elements 18, so that the fastening elements 18 can be moved by means of the actuation element 22. For example, the fastening elements 18 can be moved in the direction of the container box 10 through actuation of the actuation element 22, so that the fastening elements 18 can be unhooked from the rails of the rail system 16 and the container box 10 released. The actuation element 22 can for example be configured as pulling knob or as pushing knob, so that when exerting a force on the pushing knob the fastening elements 18 are moved in the direction of the container box 10 in order to be able to release the container box 10, and as soon as the pulling knob or the pushing knob is no longer actuated, the fastening elements 18 are moved to the outside of the container box 10, so that the container box 10 for example can be again hooked into the rails. The actuation element 22 however can also be equipped with a mechanism other than a pulling or a pushing knob.

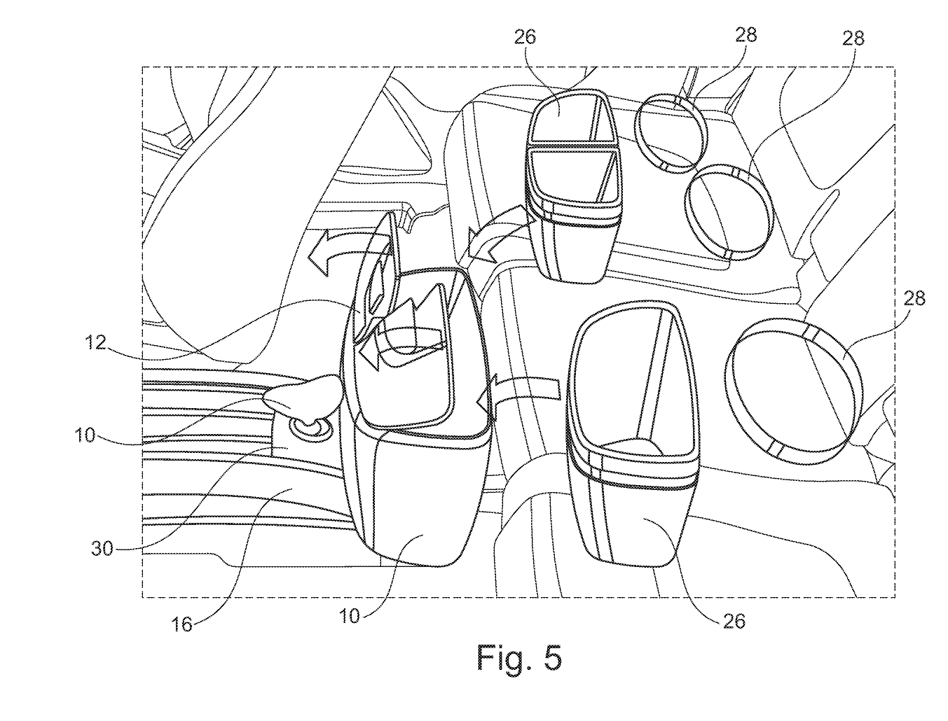

The lid element 12 can be configured foldable, rollable or collapsible. The lid element 12 can also be split as is shown in FIG. 5. For opening and/or closing of the lid element 12 the container box 10 comprises a second actuation element 24.

As is shown in FIG. 4, the container box 10 can serve as a waste container, wherein a removable holding element 26, more preferably a waste bag, for example a commercially available plastic bag, can be arranged in the container box 10. The removable holding elements 26 can, as is shown in FIG. 5, be fastened in the container box 10 by means of a fastening element 28, which can be embodied as an elastic band, for example a rubber ring, or as a metal clip or metal ring. For fastening the metal ring or the metal clip it is initially compressed and in the compressed state positioned in the container box 10. If the metal ring or the metal clip is released in this position, the metal ring or the metal clip springs apart and in the process fixes the removable holding element 26.

The container box 10 can also comprise two regions which are arranged separately from each other, for example in form of an inner box divided in two, as is shown in FIG. 5, wherein a portion can be utilized for dry waste, such as paper, and a portion for wet waste, such as apple remains.

In addition to the container box 10 the holding device can comprise a second container box 30, which can likewise be fastened in the rail system 16 of the center console 14. The second container box 30 can for example serve as storage for removable holding elements 26, such as removable waste bags, in order to always have these at hand when the removable holding element 26 (e.g., waste bag) located in the first container box 10 is to be replaced.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A holding device adapted to hold an article within an interior space of a motor vehicle, comprising:
a container box;
a closable lid element adapted to close the container box; and
a rail system adapted to be fastened to the container box; arranged in a center console of the motor vehicle.

2. The holding device according to claim 1, wherein the container box comprises a first pin-shaped fastening element adapted to fasten the container box in the rail system.

3. The holding device according to claim 2, further comprising a second pin-shaped fastening element located opposite the first pin-shaped fastening element and the second pin-shaped fastening element is coupled to the first pin-shaped fastening element with a spring mechanism.

4. The holding device according to claim 1, wherein the container box comprises a first actuation element adapted to fasten the container box to the rail system.

5. The holding device according to claim 1, wherein the container box comprises a first actuation element adapted to release the container box from the rail system.

6. The holding device according to claim 4, further comprising a second actuation element adapted to support movement of the closable lid element.

7. The holding device according to claim 1, wherein the closable lid element is adapted to fold.

8. The holding device according to claim 1, wherein the closable lid element is adapted to slide.

9. The holding device according to claim 1, wherein the closable lid element is adapted to collapse.

10. The holding device according to claim 1, further comprising a fastening element within the container box that is adapted to fasten a removable holding element.

11. The holding device according to claim 1, further comprising:
a second container box; and
a second closable lid element adapted to close the second container box.
